(19) United States
(12) Patent Application Publication
(10) Pub. No.: US 2026/0050071 A1
(43) Pub. Date: Feb. 19, 2026

(54) IMAGING SYSTEM WITH INCREASED EFFICIENCY

(71) Applicant: SiLC Technologies, Inc., Monrovia, CA (US)

(72) Inventors: Nirmal Chindhu Warke, Saratoga, CA (US); Mehdi Asghari, La Canada Flintridge, CA (US); Majid Boloorian, San Diego, CA (US)

(21) Appl. No.: 18/803,402

(22) Filed: Aug. 13, 2024

(51) Int. Cl. G01S 7/4915; G01S 7/48; G01S 17/42

(52) U.S. Cl. CPC G01S 7/4915; G01S 7/4808; G01S 17/42

(57) ABSTRACT

A LIDAR system concurrently receives multiple different system return signals that have each been reflected by an object located external to the LIDAR system. The LIDAR system has a data signal generator with multiple light sensors that each receives light from a different one of the system return signals. The data signal generator generates data signals that are each an electrical signal beating at a beat frequency. Each of the data signals is generated from the light from a different one of the system return signals. The LIDAR system includes an analog-to-digital converter configured to receive the data signal in series.

### FIELD

The invention relates to optical devices. In particular, the invention relates to LIDAR systems.

### BACKGROUND

The performance demands placed on LIDAR systems are increasing as these systems support an increasing number of applications. LIDAR systems generally generate LIDAR data for a series of sample regions that are each sequentially illuminated by a system output signal. The LIDAR data for a sample region indicates the radial velocity and/or distance between the LIDAR system and one or more objects located in the sample region. The LIDAR system can scan the system output signal to multiple different sample regions. The sample regions can be stitched together to form a field of view for the LIDAR system. As a result, the LIDAR data from the different sample regions provides the LIDAR data for objects within the field of view.

Increasing the number of system output signals that are concurrently transmitted by a LIDAR system can increase the resolution of the LIDAR system and/or increase the speed at which the field of view is scanned. However, increasing the number of system output signals that are concurrently transmitted by a LIDAR system increases the number of electrical components needed to generate the LIDAR data. As a result, there is a need for a practical LIDAR system that concurrently transmits multiple system output signals.

### SUMMARY

A LIDAR system concurrently receives multiple different system return signals that have each been reflected by an object located external to the LIDAR system. The LIDAR system has a data signal generator with multiple light sensors that each receives light from a different one of the system return signals. The data signal generator generates data signals that are each an electrical signal beating at a beat frequency. Each of the data signals is generated from the light from a different one of the system return signals. The LIDAR system includes an analog-to-digital converter configured to receive the data signal in series.

The LIDAR system can concurrently transmit M system output signals that each has a frequency versus time pattern and each of the versus time pattern can be phase shifted relative to the other frequency versus time patterns. Each of the frequency versus time patterns can have the frequency of one of the system output signals repeated in cycles and each of the frequency versus time patterns can be phase shifted by +/−(P/(2M)) relative to at least one of the other frequency versus time patterns where P represents a period of each cycle.

The LIDAR system can concurrently transmit M system output signals that each has a frequency versus time pattern and each of the versus time pattern can be phase shifted relative to the other frequency versus time patterns. Each of the frequency versus time patterns can have the frequency of one of the system output signals repeated in cycles that each includes two chirp periods where the frequency of the system output signal is linearly chirped.

The LIDAR system can include a switch the receives each of the data signals after the data signal is output from the data signal generator. The switch is also configured to output one of the data signals before the data signal is received by the analog-to-digital converter. Each of the system output signals can be associated with a different channel index (m) and the data signal generated from the system output signal associated with channel index m is also associated with channel index m. The LIDAR system includes a switch controller configured to operate the switch such that each of the different data signals is output from the switch during a different switch window. Each of the switch windows opens up at, or after, a lower time limit and closes at, or before, an upper time limit. The lower time limits occur at ((the start of each one of the chirp periods)+((M−1)/M)*(the duration of the chirp period)). The upper time limits occur at the end of the each one of the chirp periods. The data signal associated with channel index m is output from the switch during the switch windows that close at, or before, the end of the chirp periods associated with the channel index m. Each switch window closes at, or before, the earliest upper time limits that occurs after the switch window opens.

### BRIEF DESCRIPTION OF THE FIGURES

FIG. 1 is a topview of a schematic of a LIDAR chip.

FIG. 2 is a topview of a LIDAR adapter that is suitable for use with the LIDAR chip of FIG. 1.

FIG. 3A is a topview of a LIDAR system that includes the LIDAR chip and electronics of FIG. 1 and the LIDAR adapter of FIG. 2.

FIG. 3B is a topview of a LIDAR system that includes the LIDAR chip and electronics of FIG. 1 and the LIDAR adapter of FIG. 2.

FIG. 4A is a schematic of the LIDAR chip of FIG. 1 modified to be suitable for use with a LIDAR system that concurrently transmits multiple different system output signals that are each at the same wavelength.

FIG. 4B is a topview of a LIDAR adapter that is suitable for use with the LIDAR chip of FIG. 4A.

FIG. 4C is a topview of a LIDAR system that includes the LIDAR chip and electronics of FIG. 4A and the LIDAR adapter of FIG. 4B.

FIG. 5A is a schematic of an example of a suitable composite signal generator.

FIG. 5B is a schematic of an example of electronics configured to generate LIDAR data from the output of the composite signal generator shown in FIG. 5A.

FIG. 5C is a graph that illustrates an example of the frequency versus time pattern for outgoing LIDAR signals.

FIG. 5D is a graph that illustrates another example of the frequency versus time pattern for outgoing LIDAR signals.

FIG. 5E is a graph that illustrates another example of the frequency versus time pattern for outgoing LIDAR signals.

FIG. 5F is a graph that illustrates another example of the frequency versus time pattern for outgoing LIDAR signals.

FIG. 6 is a schematic of an example of a light source.

FIG. 7 is a cross section of a waveguide suitable for use as all or a portion of the waveguides on a LIDAR chip.

### DESCRIPTION

The LIDAR system concurrently transmits multiple output signals that are each associated with a different channel index. Each of the system output signals can be reflected by an object(s) located outside of the LIDAR system. The reflected light from each of the system output signals can return to the LIDAR system in a system return signal where each of the different system return signals is associated with a different one of the channel indices.

The LIDAR system uses light from each of the system return signals to generate a different data signal beating at a beat frequency. Each of the data signals is associated with a different one of the channel indices. The LIDAR system includes a beat frequency identifier configured to identify the beat frequency of each of the data signals. The beat frequency identifier includes an analog-to-digital converter that receives the data signals associated with different channel indices in series.

Prior LIDAR systems that concurrently transmitted multiple system output signals require multiple analog-to-digital converters configured such that each of the system output signals receives one of the data signals associated with different one of the channel indices. The ability of the analog-to-digital converter in the current LIDAR system to receive the data signals in series means that a single analog-to-digital converter can replace the multiple analog-to-digital converters used in prior LIDAR systems. Since analog-to-digital converters are a considerable expense in the manufacture and operation of LIDAR systems, reducing the number of analog-to-digital converters reduces the costs associated with the LIDAR system.

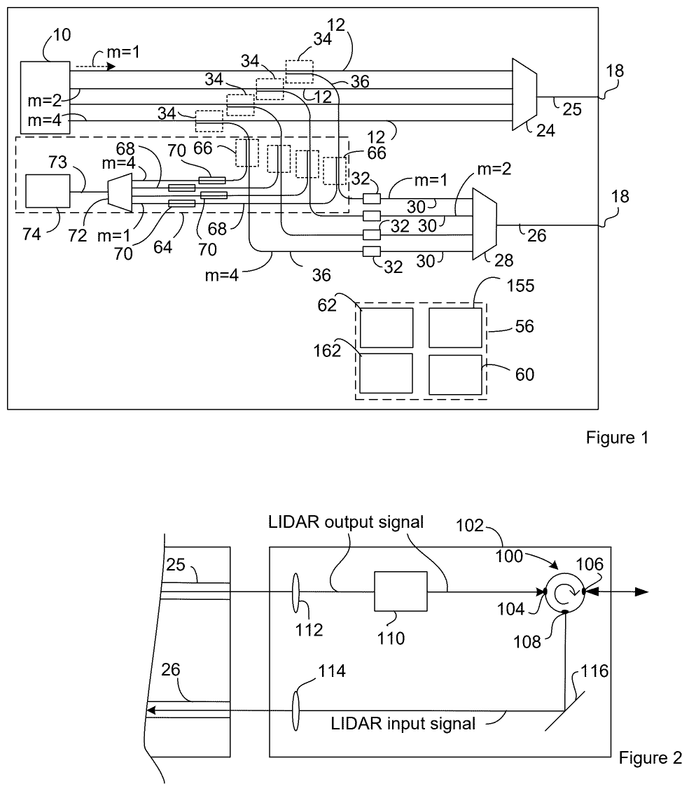

FIG. 1 is a topview of a schematic of a LIDAR chip. In some instances, the LIDAR chip is a semiconductor chip that includes a photonic circuit. The illustrated LIDAR chip includes a light source 10 that outputs multiple different outgoing LIDAR signals. Each of the different outgoing LIDAR signals is associated with a channel index with a value from m=1 to m=M. For instance, FIG. 1 illustrates the light source 10 outputting an outgoing LIDAR signal labeled m=1 and an outgoing LIDAR signal labeled m=2. Light signals processed by the LIDAR system can be associated with the channel index that is also associated with the outgoing LIDAR signal that is the source of the light signal. For instance, FIG. 1 includes a label that identifies a light signal output from the LIDAR system as associated with the channel index m=1 because the light signal includes light from the outgoing LIDAR signal labeled m=1. FIG. 1 also labels components that receive and/or process light signals associated with one of the channel indices. For instance, FIG. 1 shows the optical pathways that light signals associated with channel index m=1 travel through the LIDAR system and between the LIDAR system and an object located outside of the LIDAR system. The light signals associated with channel index m=1 and the components that receive and/or process light signals associated with channel index m=1 are labeled m=1. Additionally, light signals associated with channel index m=2 and the components that receive and/or process light signals associated with channel index m=2 are labeled m=2 in FIG. 1. In order to simplify FIG. 1, the optical pathways that light signals associated with channel index m=2 travel between the LIDAR system and an object located outside of the LIDAR system are not shown.

In some instances, the multiple different outgoing LIDAR signals are concurrently output from the light source 10. For instance, during operation of some embodiments of the LIDAR system, the light source 10 concurrently outputs the outgoing LIDAR signals associated with channel index m=1 through m=4.

The LIDAR chip also includes utility waveguides 12 that each receives a different one of the outgoing LIDAR signals from the light source 10. The LIDAR chip includes a multiplexer 24 configured to receive the outgoing LIDAR signals from the utility waveguides 12. The multiplexer 24 is configured to direct the outgoing LIDAR signals to a common waveguide such as an output waveguide 25. The multiplexer 24 combines different outgoing LIDAR signals on the output waveguide 25. Accordingly, the output waveguide 25 can carry multiple different outgoing LIDAR signals that are each associated with a different alternate waveguide index. Suitable multiplexers 24 include, but are not limited to, Arrayed Waveguide Gratings (AWGs), echelle gratings, and multiple Mach-Zehnder Interferometers (MZIs).

The LIDAR system includes one or more ports through which outgoing LIDAR signals can exit the LIDAR chip. For instance, a facet of the output waveguide 25 can serve as a port 18 through which the outgoing LIDAR signal can exit the LIDAR chip and serve as a LIDAR output signal. A facet that serves as a port can be positioned at an edge of the chip so the outgoing LIDAR signal traveling through the port exits the chip and serves as the LIDAR output signal.

The LIDAR chip can be the LIDAR system or can be included in a LIDAR system. The LIDAR system outputs one or more system output signals that are each associated with one of the channel indices. Each of the system output signals includes light from the LIDAR output signal associated with the same channel index. For instance, the system output signal associated with channel index m=2 includes light from the LIDAR output signal and the outgoing LIDAR signal associated with channel index m=2. Light from each of the system output signal travels away from the LIDAR system and may be reflected by objects in the path of the system output signal. When a system output signal is reflected, at least a portion of the reflected light can return to the LIDAR system in a system return signal. At least a portion of each system return signal can be received by the LIDAR chip as a LIDAR input signal that includes light from the system return signal. Each of the system return signals and the resulting LIDAR input signals is associated with one of the channel indices. Each of the system return signals and the resulting LIDAR input signals includes light from the system output signal associated with the same alternate waveguide index. For instance, the LIDAR input signals associated with channel index m=2 includes light from the system output signal associated with channel index m=2. In some instances, the system return signal can serve as the LIDAR input signal. For instance, when the LIDAR chip serves as the LIDAR system, the system return signal can serve as the LIDAR input signal.

The LIDAR chip includes a LIDAR input waveguide 26, a demultiplexer 28, and channel waveguides 30 that are each associated with one of the alternate waveguide indices. The LIDAR input waveguide 26 is configured to receive the LIDAR input signals and carry the LIDAR input signals to the demultiplexer 28. The demultiplexer 28 directs the LIDAR input signals to the channel waveguides 30 such that each LIDAR input signal is received by the channel waveguide that is associated with the same channel index as the LIDAR input signal. Accordingly, each of the channel waveguides 30 and the LIDAR input signal received by the channel waveguide 30 are associated with the same channel index. As an example, the channel waveguide 30 associated with channel index m=1 can receive the LIDAR input signal associated with channel index m=1 and the channel waveguide 30 associated with channel index m=2 can receive the LIDAR input signal associated with channel index m=2. Suitable demulitplexers 28 include, but are not limited to, Arrayed Waveguide Gratings (AWGs), echelle gratings, and multiple Mach-Zehnder Interferometers (MZIs).

The portion of the LIDAR input signal that enters a channel waveguide 30 can serve as a comparative signal that includes or consists of light from the LIDAR input signal. Each of the channel waveguides 30 is configured to carry the comparative signal received by that channel waveguide 30 to one of multiple different composite signal generators 32. Each of the composite signal generators 32 is associated with one of channel indices. For instance, each of the composite signal generators 32 and the comparative signals received by the composite signal generator 32 are associated with the same channel index. As an example, the comparative signal associated with channel index m=1 is received at the composite signal generator 32 associated with channel index m=1.

A splitter 34 is positioned along each of the utility waveguides. Each of the splitters 34 is configured to receive an outgoing LIDAR signal from a first portion of the utility waveguide 12. The outgoing LIDAR signal that a splitter 34 receives from the first portion of the utility waveguide 12 can be considered a preliminary outgoing LIDAR signal. Each of the splitters 34 is configured to output a first portion of the outgoing LIDAR on a second portion of the utility waveguide 12. Accordingly, the first portion of the outgoing LIDAR can continue to serve as the outgoing LIDAR signal. Each splitter 34 is also configured to output a second portion of the outgoing LIDAR signal on a reference waveguide 36. Suitable splitters 34 include, but are not limited to, directional couplers, optical couplers, y-junctions, tapered couplers, and Multi-Mode Interference (MMI) devices. When the splitter 34 is a directional coupler the splitter 34 moves a portion of the outgoing LIDAR signal from the utility waveguide 12 onto a reference waveguide 36 as a reference signal. Each reference waveguide 36 carries the reference signal to one of the composite signal generators 32 for further processing. The reference waveguides are arranged such that the composite signal generator 32 receives a comparative signal and a reference signal associated with the same channel index. Although FIG. 1 illustrates directional couplers operating as the splitters 34, other signal tapping components can be used as the splitter 34. Suitable splitters 34 include, but are not limited to, directional couplers, optical couplers, y-junctions, tapered couplers, and Multi-Mode Interference (MMI) devices.

The LIDAR system can include electronics 56. The electronics 56 can include a light source controller 62. The light source controller 62 can operate the light source 10 such that each of the outgoing LIDAR signals, and accordingly, the resulting system output signals, has a particular frequency versus time pattern. For instance, the light source controller 62 can operate the light source such that each of the outgoing LIDAR signals, and accordingly the resulting system output signals, has different chirp rates during different data periods.

The LIDAR chip can optionally include one or more control branches 64 for controlling the operation of the light source 10. For instance, the one or more control branches 64 can provide a feedback loop that the light source controller 62 uses in operating the light source such that the outgoing LIDAR signals have the desired frequency versus time pattern. In FIG. 1, a control branch 64 includes multiple splitters 66 that are each positioned along one of the reference waveguides 36. Each of the splitters 66 is configured to receive a reference signal from a first portion of the reference waveguide 36 and to output a first portion of the reference signal on a second portion of the reference waveguide 36. Accordingly, the first portion of the reference signal continues to serve as the reference signal. Each splitter 66 is also configured to output a second portion of the reference LIDAR signal on a control waveguide 38. Suitable splitters 66 include, but are not limited to, directional couplers, optical couplers, y-junctions, tapered couplers, and Multi-Mode Interference (MMI) devices. When the splitter 66 is a directional coupler the splitter 66 moves the second portion of the reference signal from the reference waveguide 36 onto a control waveguide 68 as a control signal.

An optical attenuator 70 is positioned along each of the control waveguides 68 and each control waveguide 68 carries one of the control signals to a control multiplexer 72. The control multiplexer 72 is configured to direct the control signals to a second control waveguide 73. The optical attenuators 70 can be operated by the light source controller 62. The light source controller 62 can operate the optical attenuators 70 so as to select which of the control signals is received at the control multiplexer 72. Suitable control mulitplexers 72 include, but are not limited to, Arrayed Waveguide Gratings (AWGs), echelle gratings, and multiple Mach-Zehnder Interferometers (MZIs).

Since the control multiplexer 72 directs the control signals to the second control waveguide 73, the light source controller 62 can operate the optical attenuators 70 so as to select which of the control signals is received at second control waveguide 73. The light source controller 62 can operate the optical attenuators 70 such that second control waveguide 73 receives control signals associated with different alternate waveguide indices in series. For instance, the light source controller 62 can operate the optical attenuators 70 such that second control waveguide 73 receives control signals in repeated series where each series includes the control signal associated with m=1, followed by the control signal associated with m=2, followed by the control signal associated with m=3, followed by the control signal associated with m=4.

The second control waveguide 28 carries the control signals to a feedback system 74. The feedback system 74 can include one or more light sensors (not shown) that convert the control signals to electrical signals that are output from the feedback system 74. The light source controller 62 can receive the electrical signals output from the feedback system 74. During operation, the light source controller 62 can adjust the frequency of the outgoing LIDAR signals in response to output from the electrical signals output from the feedback system 74. An example of a suitable construction and operation of feedback system 74 and light source controller 62 is provided in U.S. patent application Ser. No. 16/875,987, filed on 16 May 2020, entitled “Monitoring Signal Chirp in outbound LIDAR signals,” and incorporated herein in its entirety; and also in U.S. patent application Ser. No. 17/244,869, filed on 29 Apr. 2021, entitled “Reducing Size of LIDAR System Control Assemblies,” and incorporated herein in its entirety.

Although FIG. 1 illustrates the splitters 66 positioned along the reference waveguides 36, the splitters 66 can be positioned along the utility waveguides 12.

In some instances, a LIDAR chip constructed according to FIG. 1 is used in conjunction with a LIDAR adapter. In some instances, the LIDAR adapter can be physically optically positioned between the LIDAR chip and the one or more reflecting objects and/or the field of view in that an optical path that the first LIDAR input signal(s) and/or the LIDAR output signal travels from the LIDAR chip to the field of view passes through the LIDAR adapter. Additionally, the LIDAR adapter can be configured to operate on the LIDAR input signal and the LIDAR output signal such that the LIDAR input signal and the LIDAR output signal travel on different optical pathways between the LIDAR adapter and the LIDAR chip but on the same optical pathway between the LIDAR adapter and a reflecting object in the field of view.

An example of a LIDAR adapter that is suitable for use with the LIDAR chip of FIG. 1 is illustrated in FIG. 2. The LIDAR adapter includes multiple components positioned on a base. For instance, the LIDAR adapter includes a circulator 100 positioned on a base 102. The illustrated optical circulator 100 includes three ports and is configured such that light entering one port exits from the next port. For instance, the illustrated optical circulator includes a first port 104, a second port 106, and a third port 108. The LIDAR output signal enters the first port 104 from the utility waveguide 12 of the LIDAR chip and exits from the second port 106.

The LIDAR adapter can be configured such that the output of the LIDAR output signal from the second port 106 can also serve as the output of the LIDAR output signal from the LIDAR adapter and accordingly from the LIDAR system. As a result, the LIDAR output signal can be output from the LIDAR adapter such that the LIDAR output signal is traveling toward a sample region in the field of view. Accordingly, in some instances, the portion of the LIDAR output signal that has exited from the LIDAR adapter can also be considered the system output signal. As an example, when the exit of the LIDAR output signal from the LIDAR adapter is also an exit of the LIDAR output signal from the LIDAR system, the LIDAR output signal can also be considered a system output signal.

The LIDAR output signal output from the LIDAR adapter includes, consists of, or consists essentially of light from the LIDAR output signal received from the LIDAR chip. Accordingly, the LIDAR output signal output from the LIDAR adapter may be the same or substantially the same as the LIDAR output signal received from the LIDAR chip. However, there may be differences between the LIDAR output signal output from the LIDAR adapter and the LIDAR output signal received from the LIDAR chip. For instance, the LIDAR output signal can experience optical loss as it travels through the LIDAR adapter and/or the LIDAR adapter can optionally include an amplifier configured to amplify the LIDAR output signal as it travels through the LIDAR adapter.

When one or more objects in a sample region reflect a system output signal, at least a portion of the reflected light travels back to the circulator 100 as a system return signal. Any concurrently present system return signals can enter the circulator 100 through the second port 106. FIG. 2 illustrates each LIDAR output signal and one of the system return signals traveling between the LIDAR adapter and one of the sample regions along the same optical path.

The system return signal exits the circulator 100 through the third port 108 and is directed to the comparative waveguide 18 on the LIDAR chip. Accordingly, all or a portion of the system return signal can serve as the first LIDAR input signal and the first LIDAR input signal includes or consists of light from the system return signal. Accordingly, the LIDAR output signal and the first LIDAR input signal travel between the LIDAR adapter and the LIDAR chip along different optical paths.

As is evident from FIG. 2, the LIDAR adapter can include optical components in addition to the circulator 100. For instance, the LIDAR adapter can include components for directing and controlling the optical path of the LIDAR output signal and the system return signal. As an example, the adapter of FIG. 2 includes an optional amplifier 110 positioned so as to receive and amplify the LIDAR output signal before the LIDAR output signal enters the circulator 100. The amplifier 110 can be operated by the electronics 56 allowing the electronics 56 to control the power of the LIDAR output signal. Suitable amplifiers include, but are not limited to, Semiconductor Optical Amplifiers (SOAs), optical fiber-based amplifiers, or optical waveguide-based amplifiers. In some instances, the amplifier 110 is an Erbium-doped fiber amplifier (EDFAs) or Erbium-doped waveguide amplifier (EDWAs). Erbium-doped fiber amplifiers (EDFAs) or Erbium-doped waveguide amplifier (EDWAs) can efficiently provide the system output signals with sufficient power levels at distances greater than or equal to 1 km from the preliminary LIDAR system or the secondary LIDAR system. Erbium-doped fiber amplifiers (EDFAs) can provide the system output signals with a power level greater than or equal to 1 W or 3 W at distances greater than or equal to 1 km from the preliminary LIDAR system or the secondary LIDAR system.

FIG. 2 also illustrates the LIDAR adapter including an optional first lens 112 and an optional second lens 114. The first lens 112 can be configured to couple the LIDAR output signal to a desired location. In some instances, the first lens 112 is configured to focus or collimate the LIDAR output signal at a desired location. In one example, the first lens 112 is configured to couple the LIDAR output signal on the first port 104 when the LIDAR adapter does not include an amplifier 110. As another example, when the LIDAR adapter includes an amplifier 110, the first lens 112 can be configured to couple the LIDAR output signal on the entry port to the amplifier 110. The second lens 114 can be configured to couple the system return signals at a desired location. In some instances, the second lens 114 is configured to focus or collimate the system return signals at a desired location. For instance, the second lens 114 can be configured to couple the system signals on a facet of an input waveguide 26.

The LIDAR adapter can also include one or more direction changing components such as mirrors. FIG. 2 illustrates the LIDAR adapter including a mirror as a direction-changing component 116 that redirects the system return signal from the circulator 100 to the facet 20 of the comparative waveguide 18.

The LIDAR chips include one or more waveguides that constrains the optical path of one or more light signals. While the LIDAR adapter can include waveguides, the optical path that the system return signal and the LIDAR output signal travel between components on the LIDAR adapter and/or between the LIDAR chip and a component on the LIDAR adapter can be free space. For instance, the system return signal and/or the LIDAR output signal can travel through the atmosphere in which the LIDAR chip, the LIDAR adapter, and/or the base 102 is positioned when traveling between the different components on the LIDAR adapter and/or between a component on the LIDAR adapter and the LIDAR chip. As a result, optical components such as lenses and direction changing components can be employed to control the characteristics of the optical path traveled by the system return signal and the LIDAR output signal on, to, and from the LIDAR adapter.

Suitable bases 102 for the LIDAR adapter include, but are not limited to, substrates, platforms, and plates. Suitable substrates include, but are not limited to, glass, silicon, and ceramics. The components can be discrete components that are attached to the substrate. Suitable techniques for attaching discrete components to the base 102 include, but are not limited to, epoxy, solder, and mechanical clamping. In one example, one or more of the components are integrated components and the remaining components are discrete components. In another example, the LIDAR adapter includes one or more integrated amplifiers, and the remaining components are discrete components.

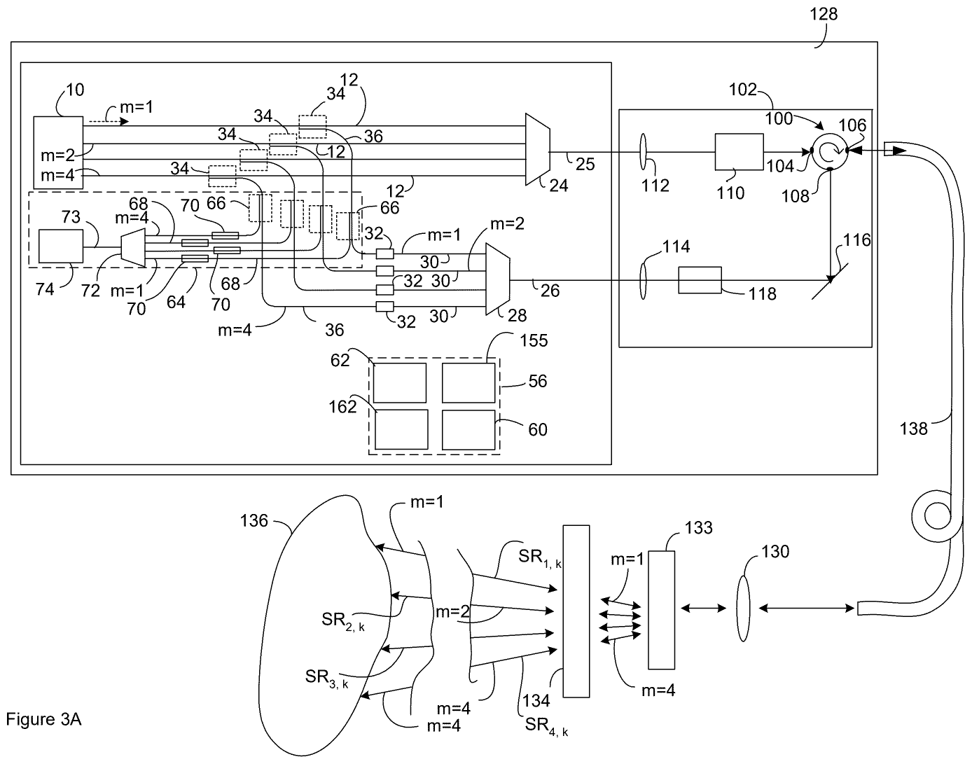

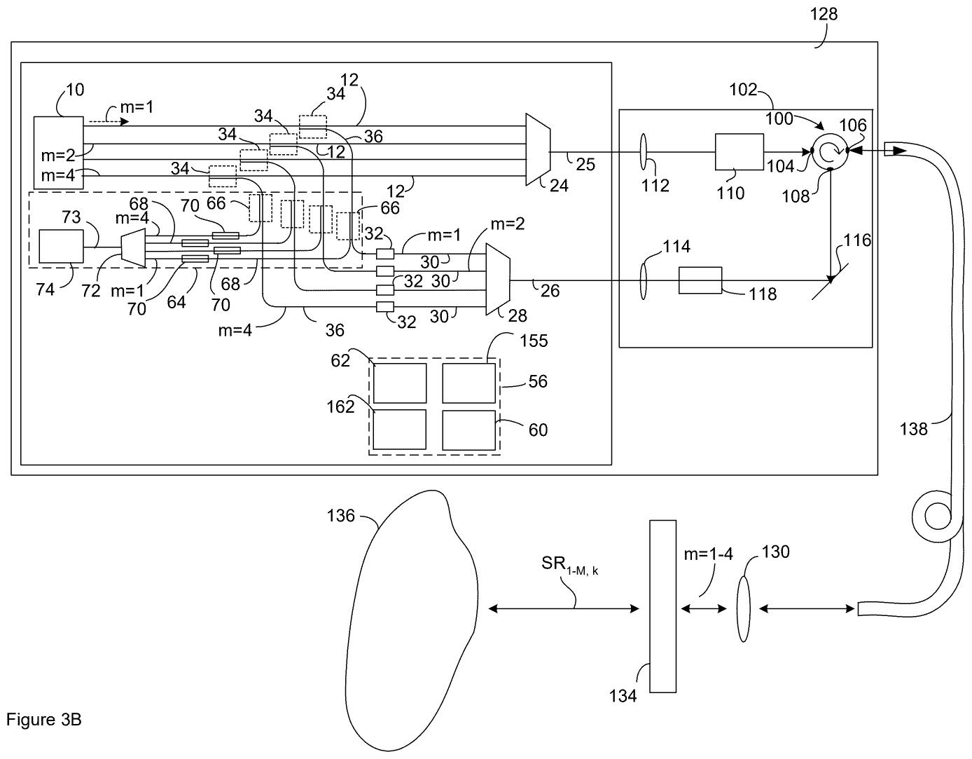

When the LIDAR system includes a LIDAR chip and a LIDAR adapter, the LIDAR chip, electronics, and the LIDAR adapter can be positioned on a common mount. Suitable common mounts include, but are not limited to, glass plates, metal plates, silicon plates and ceramic plates. As an example, FIG. 3A is a topview of a LIDAR system that includes the LIDAR chip and electronics 56 of FIG. 1 and the LIDAR adapter of FIG. 2 on a common mount 128. Although the electronics 56 are illustrated as being located on the common support, all or a portion of the electronics can be located off the common support. When the light source 4 is located off the LIDAR chip, the light source can be located on the common mount 128 or off the common mount 128.

Although FIG. 3A illustrates the electronics 56 as located on the common mount 128, all or a portion of the electronics can be located off the common mount 128. When the light source 10 is located off the LIDAR chip, the light source can be located on the common mount 128 or off of the common mount 128. Suitable approaches for mounting the LIDAR chip, electronics, and/or the LIDAR adapter on the common mount 128 include, but are not limited to, epoxy, solder, and mechanical clamping. Suitable common mounts 128 include, but are not limited to, substrates such as glass plates, metal plates, silicon plates and ceramic plates.

The LIDAR systems of FIG. 3A can include one or more system components that are at least partially located off the common mount 128. Examples of suitable system components include, but are not limited to, optical links, beam shapers, polarization state rotators, beam scanners, optical splitters, optical amplifiers, wavelength chromatic dispersers, and optical attenuators. The LIDAR system of FIG. 3A includes one or more beam shapers 130 that receive the LIDAR output signals from the adapter and output a shaped versions of each one of the LIDAR output signals. The one or more beam shapers 130 can be configured to provide the LIDAR output signals with the desired shape. For instance, the one or more beam shapers 130 can be configured to output shaped LIDAR output signals signal that are focused, diverging or collimated. In FIG. 3A, the one or more beam shapers 130 is a lens that is configured to output a collimated LIDAR output signal.

The LIDAR system of FIG. 3A includes a includes a wavelength chromatic disperser 133 that receives the LIDAR output signals from the one or more beam shapers 130. When the LIDAR system excludes the one or more beam shapers 130, the wavelength chromatic disperser 133 can receive the wavelength chromatic disperser 133 can receive the LIDAR output signals from the adapter or one or more of the one or more system components depending on the configuration of the LIDAR system.

In some instances, the wavelength chromatic disperser 133 receives all or a portion of the LIDAR output signals. The wavelength chromatic disperser 133 is configured to cause chromatic dispersion such that direction that a LIDAR output signal travels away from the wavelength chromatic disperser 133 is a function of the wavelength carried by the LIDAR output signals. For instance, the direction that a LIDAR output signal travels away from the wavelength chromatic disperser 133 changes in response to changes in the wavelength channel carried by the outbound LIDAR signal. As a result, when the LIDAR output signals have different wavelengths, the wavelength chromatic disperser 133 can cause the different LIDAR output signals to travel away from the wavelength chromatic disperser 133 in different directions. Accordingly, the wavelength chromatic disperser 133 can act as a splitter that separates the optical pathways of the LIDAR output signals. The LIDAR system can be constructed such that the system output signals transmitted from the LIDAR system travel away from the LIDAR system in different direction as a result of the LIDAR output signals traveling away from the wavelength chromatic disperser 133 in different directions.

Suitable wavelength chromatic dispersers 77 can include or consist of one or more dispersive media and/or have a wavelength dependent refractive index. Examples of suitable wavelength chromatic dispersers 77 include, but are not limited to, reflective diffraction gratings, transmissive diffraction gratings, and prisms. In some instances, the wavelength chromatic disperser 133 is configured to provide a level of dispersion greater than 0.005°/nm, 0.05°/nm, 0.1°/nm, or 0.2°/nm and less than 0.3°/nm, 0.4°/nm, or 0.5°/nm.

The LIDAR systems of FIG. 3A can optionally include one or more beam scanners 134 that receive the LIDAR output signals from the wavelength chromatic disperser 133 and that output the system output signal. As shown in FIG. 3A, the system output signals travel away from the LIDAR system in different directions as a result of the LIDAR output signals traveling away from the wavelength chromatic disperser 133 in different directions. As a result, the system output signals can each concurrently illuminate different a different sample region in the LIDAR system's field of view.

The electronics 56 can include a steering controller 60 configured to operate the one or more beam scanners 134 so as to steer the each of the system output signals to a series of different sample regions within the field of view of the LIDAR system. The sample regions can extend away from the LIDAR system to a maximum operational distance for which the LIDAR system is configured to provide reliable LIDAR data. When the system output signals travel away from the LIDAR system in different directions, the spot sizes of system output signals concurrently transmitted from the LIDAR system do not overlap at the maximum operational distance of the LIDAR system. The sample regions can be stitched together to define the field of view. For instance, the field of view of for the LIDAR system includes or consists of the space occupied by the combination of the sample regions. As a result, the sample regions can serve as three-dimensional pixels. Suitable beam scanners include, but are not limited to, movable mirrors, MEMS mirrors, optical phased arrays (OPAs), optical gratings, actuated optical gratings and actuators that move the LIDAR chip, LIDAR adapter, and/or common mount 128.

System output signals that carry different channels can be concurrently output from the LIDAR system.

When a system output signal is reflected by an object 136 located outside of the LIDAR system and the LIDAR, at least a portion of the reflected light returns to the LIDAR system as a system return signal. Although FIG. 3A shows each of the system output signals by the same object, all, or a portion, of the system output signals can each be reflected by a different object.

When the LIDAR system includes one or more beam scanners 134, the one or more beam scanners 134 can receive system return signal(s) reflected by the object(s) 136. The wavelength chromatic disperser 133 can receive the system return signal(s) from the one or more beam scanners 134 and can combine the one or more system return signals. The one or more beam shapers 130 receive the system return signal(s) from the wavelength chromatic disperser 133. The one or more beam shapers 130 output one or more shaped system return signal(s) that are received by the adapter.

The LIDAR system of FIG. 3A includes an optional optical link 138 that carries the LIDAR output signals to the one or more system components from the adapter, from the LIDAR chip, and/or from one or more components on the common mount. For instance, the LIDAR system of FIG. 3A includes an optical fiber configured to carry the LIDAR output signals to the beam shapers 130. The use of the optical link 138 allows the source of the system output signal to be located remote from the LIDAR chip. Although the illustrated optical link 138 is an optical fiber, other optical links 138 can be used. Suitable optical links 138 include, but are not limited to, free space optical links and waveguides. When the LIDAR system excludes an optical link, the one or more beam shapers 130 can receive the LIDAR output signals directly from the adapter.

The LIDAR systems of FIG. 3A is described as concurrently transmitting multiple different system output signals that each illuminates a different sample region in a field of view. However, the LIDAR system can be modified such that the different system output signals concurrently illuminate the same sample region in the field of view. As an example, FIG. 3B illustrates the LIDAR system of FIG. 3A modified such that the different system output signals concurrently illuminate the same sample region in the field of view. In particular, the LIDAR system of FIG. 3B excludes the wavelength chromatic disperser 133 of FIG. 3A. As a result, the LIDAR output signals are not separated as they travel away from the one or more beam shapers 130 and/or to the one or more beam scanners 134. Accordingly, the LIDAR output signals can travel the same optical pathway as they travel away from the one or more beam shapers 130 and/or to the one or more beam scanners 134. As a result, the resulting system output signals can also travel the same optical pathway as they travel away from the LIDAR system. As a result of traveling the same optical pathway, the spot sizes of the system output signals can overlap in the same sample region. In some instances, the spot sizes of system output signals concurrently transmitted from the LIDAR system overlap at the maximum operational distance of the LIDAR system. For instance, at the maximum operational distance of the LIDAR system, each of the system output signals concurrently transmitted from the LIDAR system can have a spot size that overlaps with one or more of the other system output signals concurrently transmitted from the LIDAR system by at least 50%, 90%, or 100% of the spot size of the system output signal. As a result, the system output signals can overlap for the full length of the sample region extending from the LIDAR system to the maximum operational distance of the LIDAR system.

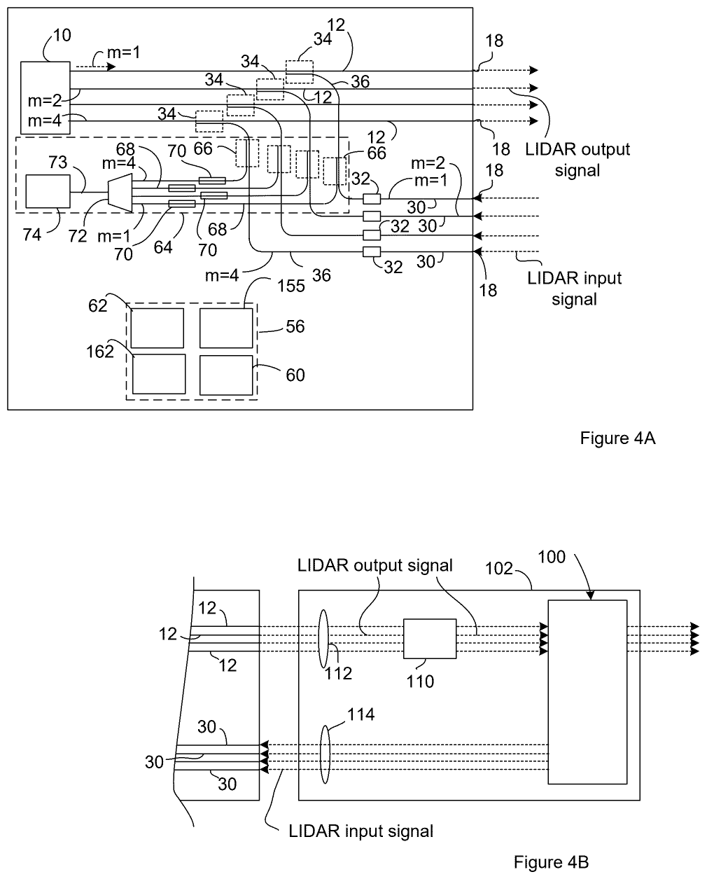

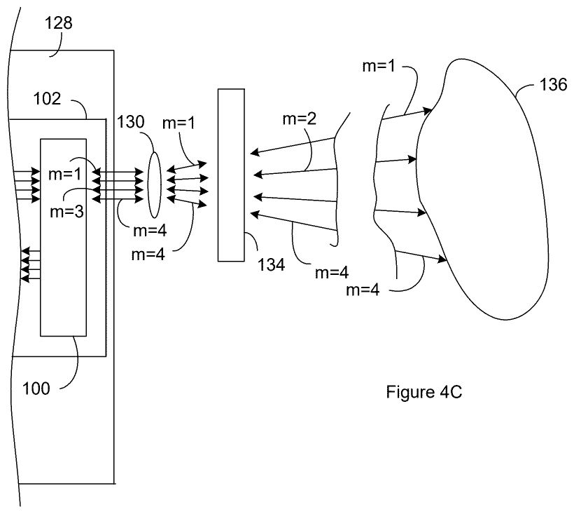

The LIDAR systems of FIG. 3A and FIG. 3B are described as concurrently transmitting multiple different system output signals that are each at a different wavelength. However, the LIDAR system can be modified such that the different system output signals have the same wavelength. As an example, FIG. 4A is a schematic of the LIDAR chip of FIG. 1 modified to be suitable for use with a LIDAR system that concurrently transmits multiple different system output signals that are each at the same wavelength. The LIDAR chip is modified such that each of the utility waveguides 12 carries one of the outgoing LIDAR signals to a port 18 through which the outgoing LIDAR signal can exit the LIDAR chip and serve as one of the LIDAR output signals. For instance, a facet of a utility waveguide 12 can serve as a port 18 through which the outgoing LIDAR signal can exit the LIDAR chip and serve as a LIDAR output signal. A facet that serves as a port can be positioned at an edge of the chip so the outgoing LIDAR signal traveling through the port exits the chip and serves as the LIDAR output signal. As is evident from FIG. 4A, the LIDAR output signals are physically separated. As a result, the LIDAR chip can be configured to transmit LIDAR output signals that are physically separated and/or spaced apart.

The LIDAR chip of FIG. 4A is also modified such that each of the channel waveguides 30 is in optical communication with a different port 18. Each of the channel waveguides 30 can receive a different one of the LIDAR input signals through a port 18 through which one of the LIDAR input signals can enter the LIDAR chip and serve as one of the comparative signals. For instance, a facet of a channel waveguides 30 can serve as a port 18 through which the LIDAR input signal can enter the LIDAR chip and serve as one of the comparative signals. A facet that serves as a port can be positioned at an edge of the LIDAR chip so the LIDAR input signal traveling through the port enters the chip and serves as one of the comparative signals. As is evident from FIG. 4A, the LIDAR input signals are physically separated. As a result, the LIDAR chip can be configured to receive LIDAR input signals that are physically separated and/or spaced apart.

FIG. 4B is a schematic of the adapter of FIG. 2 modified to be suitable for use with a LIDAR system that concurrently transmits multiple different system output signals that are each at the same wavelength. The adapter is modified such that the circulator 100 and the optional first lens 112 are each configured to receive multiple physically separated and/or spaced apart LIDAR input signals and the optional second lens 114 are each configured to receive multiple physically separated and/or spaced apart LIDAR input signals. Examples of a suitable adapter construction, circulator 100 construction, and/or LIDAR chip construction can be found in U.S. patent application Ser. No. 17/221,770, filed on Apr. 2, 2021, entitled “Use of Circulator in LIDAR System,” and incorporated herein in its entirety.

FIG. 4C FIG. 3A is a schematic of a LIDAR system that includes the LIDAR chip and electronics of FIG. 4A and the LIDAR adapter of FIG. 4B. The adapter is configured such that the LIDAR output signals that are transmitted by (output from) the adapter and associated with different channel indices are spatially separated as shown in FIG. 4B and FIG. 4C. The spatially separated LIDAR output signals can have different angles of incidence on a beam shaper 130 such as a lens. The different angles of incidence can cause the different LIDAR output signals to travel away from the beam shaper 130 in different directions as illustrated in FIG. 4C. Since the difference in the directions that the LIDAR output signals travel away from the beam shaper 130 results from the different angles of incidence, all or a portion of the different LIDAR output signals can have the same wavelength. Alternately, all or a portion of the different LIDAR output signals can have different wavelengths. The LIDAR system can be configured such that the system output signals transmitted from the LIDAR system travel away from the LIDAR system in different direction as a result of the LIDAR output signals traveling away from the beam shaper 130 in different directions. The LIDAR chip and adapter can also be configured such that the different system return signals are each associated with a different channel index and are each a source of a different comparative signal. The comparative signals associated with different channel indices are directed to different composite signal generators 32.

The LIDAR systems of FIG. 4A through FIG. 4C are described as concurrently transmitting multiple different system output signals that are each at the same wavelength. However, the LIDAR system can be modified such that different system output signals have different wavelengths.

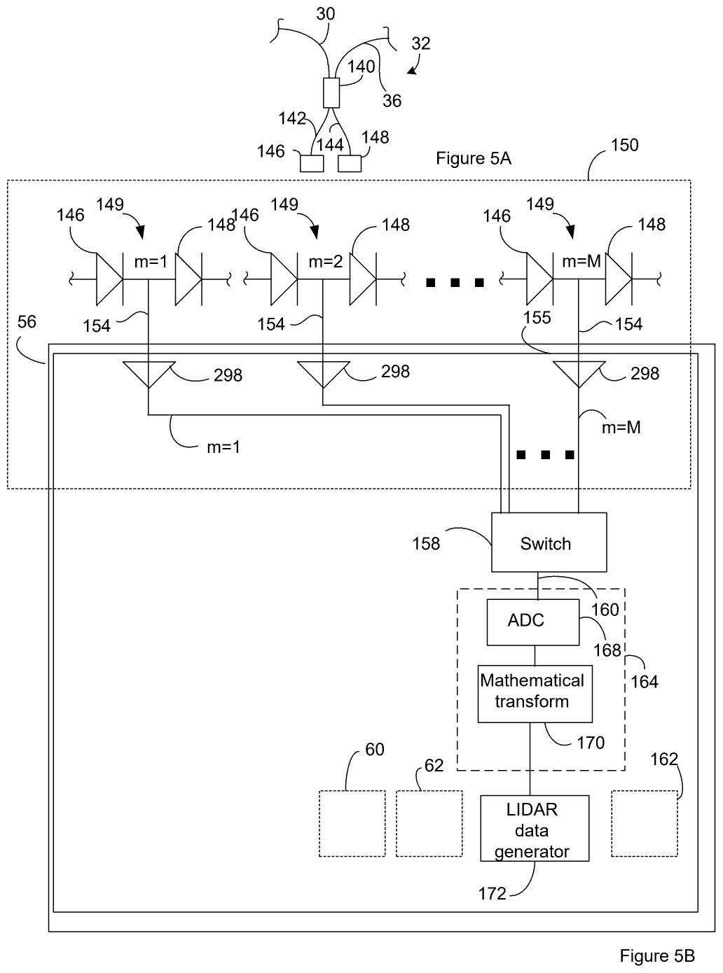

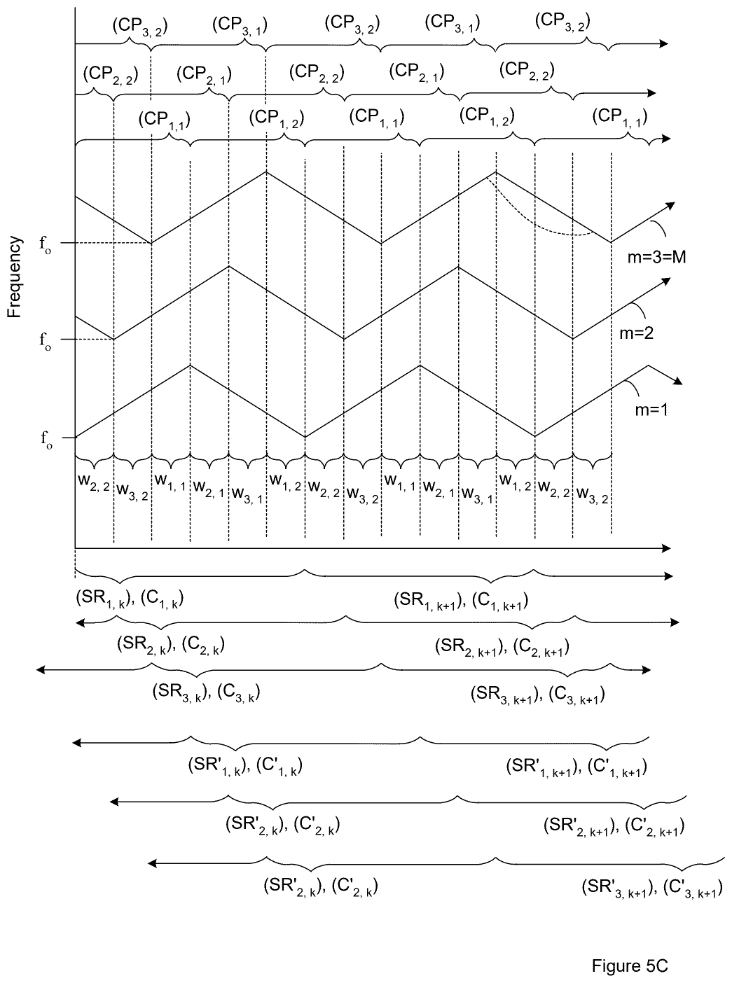

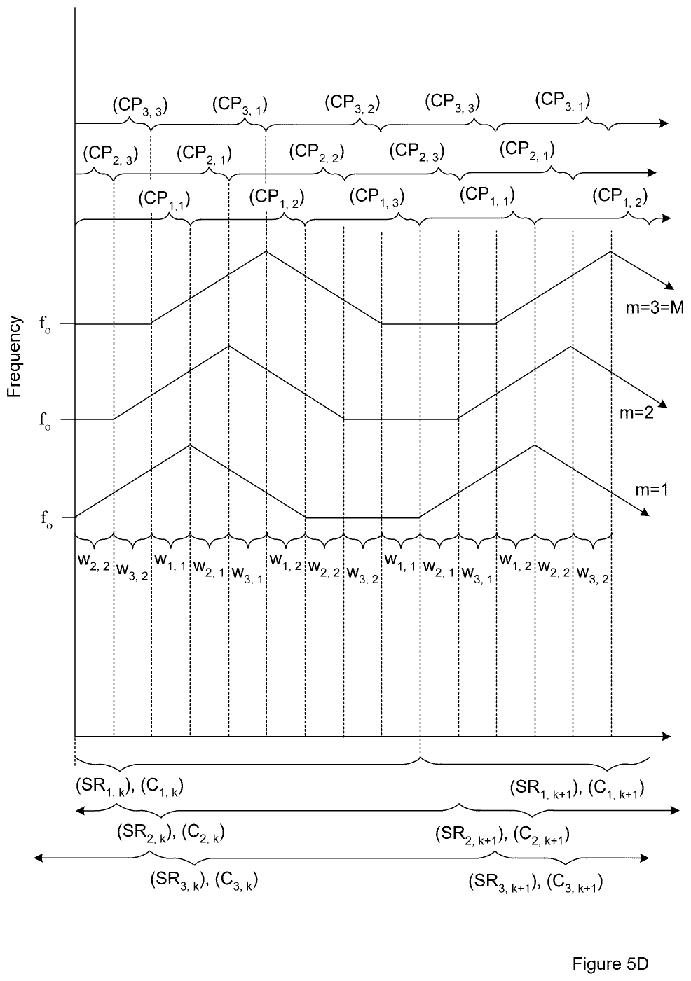

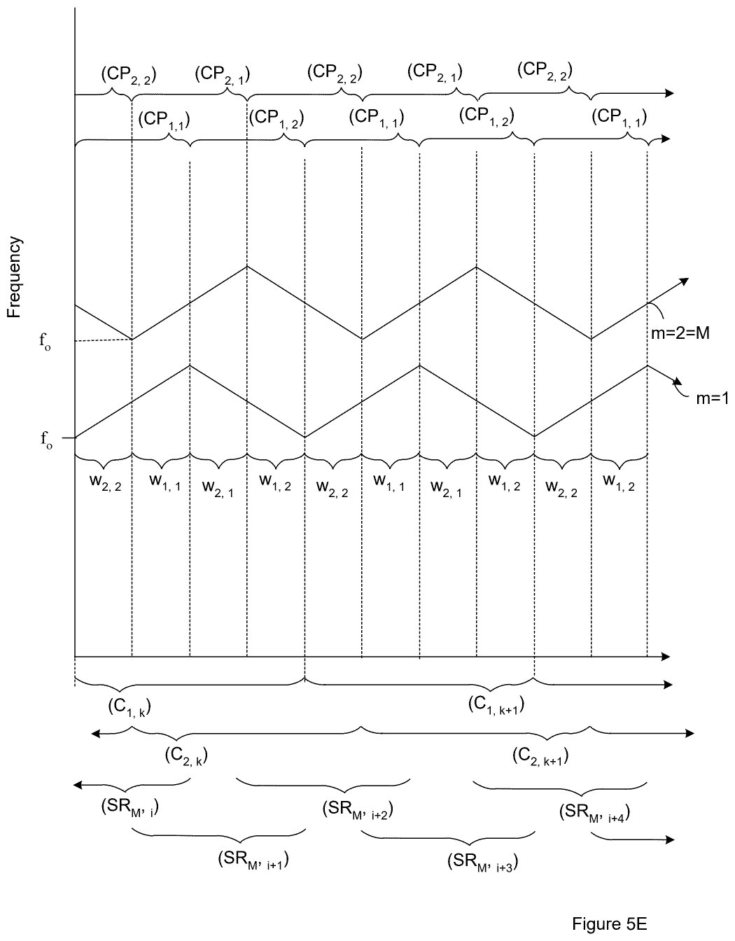

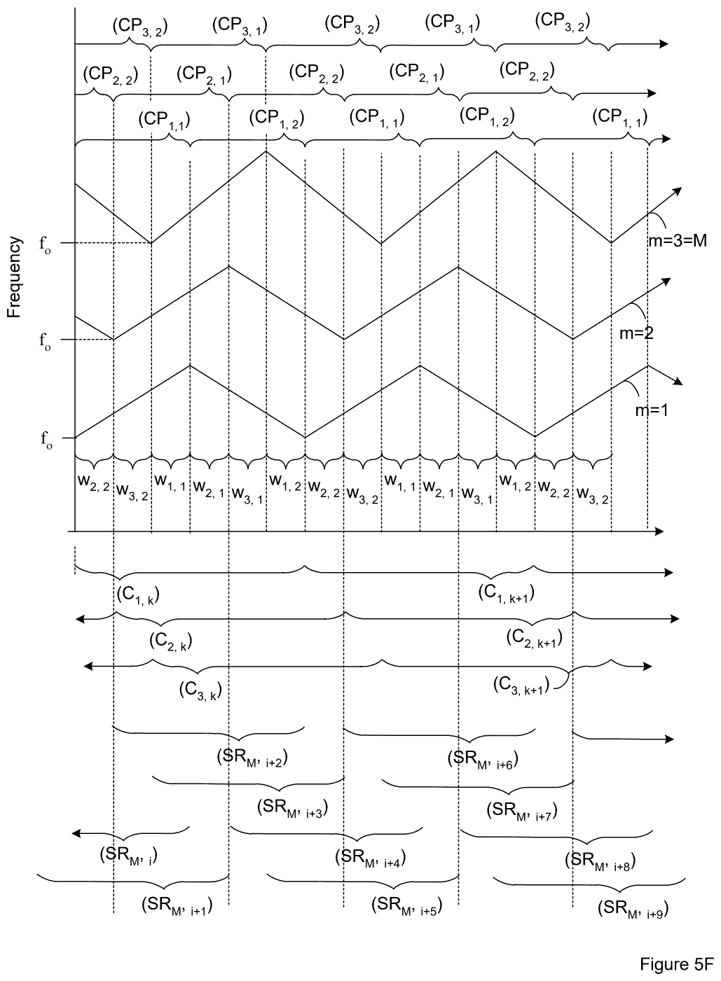

FIG. 5A illustrates an example of a composite signal generator 32 that is suitable for use as any, all, or each of the composite signal generators 32 in the LIDAR chip of FIG. 1. The illustrated composite signal generator 32 includes a light signal combiner 140 configured to receive light signals from one of the reference waveguides 36 and one of the comparative waveguides 30. When the reference waveguide 36 receives a reference signal, the reference waveguide 40 carries the reference signal to the light signal combiner 140. When a channel waveguide 30 receives a comparative signal, the channel waveguide 30 carries the comparative signal to the light signal combiner 140. When the light signal combiner 140 receives a comparative signal and a reference signal, the light signal combiner 140 combines the comparative signal and the reference signal into a composite signal. Due to a difference in frequencies between the comparative signal and the reference signal, the composite signal is beating at a beat frequency.

The light signal combiner 140 also splits the composite signal onto a first detector waveguide 142 and a second detector waveguide 144. The first detector waveguide 142 carries a first portion of the composite signal to a first light sensor 146 that converts the first portion of the composite signal to a first electrical signal. The second detector waveguide 144 carries a second portion of the composite signal to a second light sensor 148 that converts the second portion of the composite signal to a second electrical signal. Examples of suitable light sensors include germanium photodiodes (PDs), and avalanche photodiodes (APDs).

In some instances, the light signal combiner 140 splits the composite signal such that the portion of the comparative signal included in the first portion of the composite signal is phase shifted by 180° relative to the portion of the comparative signal in the second portion of the composite signal but the portion of the reference signal in the first portion of the composite signal is not phase shifted relative to the portion of the reference signal in the second portion of the composite signal. Alternately, the light signal combiner 140 splits the composite signal such that the portion of the reference signal in the first portion of the composite signal is phase shifted by 180° relative to the portion of the reference signal in the second portion of the composite signal but the portion of the comparative signal in the first portion of the composite signal is not phase shifted relative to the portion of the comparative signal in the second portion of the composite signal.

Suitable light signal combiners that can serve as the light signal combiner 140 include, but are not limited to, a Multi-Mode Interference (MMI) device such as a 2×2 MMI device. Other suitable light signal combiners include, but are not limited to, adiabatic splitters, and directional couplers. In some instances, the functions of the light signal combiner are performed by more than one optical component or a combination of optical components.

The LIDAR chip can include multiple composite signal generator 32 as shown in FIG. 1. FIG. 5B illustrates an example of a portion of the electronics configured to process the output from multiple different composite signal generators 32 that are each associated with a different one of the channel indices. The electronics 56 include a data signal generator 150 that includes the first light sensor 146 and the second light sensor 148 in each of the composite signal generators 32. The first light sensor 146 and the second light sensor 148 in each of the composite signal generators 32 can be connected as a balanced detector that serves as a light detector 149 that converts optical energy to electrical energy. As noted above, the different composite signal generators 32 are associated with different channel indices. Accordingly, the light detectors in different composite signal generator 32 are each associated with a different one of the channel indices.

The data signal generator 150 includes multiple detector output line 154. Each light detector is in electrical communication with a different one of the detector output lines 154 such that each of the detector output lines 154 carries the output signal of a different one of the light detectors as a data signal. For instance, the serial connection in the balanced detectors is in communication with one of the detector output lines 154. The electronics 56 include a data processor 155 configured to generate LIDAR data for the sample regions. Since the system output signals can be concurrently transmitted from the LIDAR system, there may be data signals present on one or more of the detector output lines 154. As a result, there may be data signals associated with different channel indices concurrently present on different detector output lines 154.

The data processor 155 includes a switch 158 configured to receive each of the data signals from the light detectors 149. In particular, the switch 158 can be configured to receive the data signals from the from the detector output lines 154. As a result, each of the detector output lines 154 can serve as a switch input line. Since the system output signals can be concurrently transmitted from the LIDAR system, there may be data signals concurrently present on one or more of the detector output lines 154. As a result, there may be data signals associated with different channel indices concurrently present on different detector output lines 154.

The switch 158 is operable so as to output selection of the data signals on an analog signal line 160. Accordingly, the switch 158 can be operated so as to select which of the data signals are output on the analog signal line. In some instances, the selection of the data signals output on an analog signal line 160 is a single one of the data signals. For instance, the switch 158 can be operated such that the data signal associated with channel index m=1 is output on the analog signal line and the other data signals are not output on the analog signal line, or are not substantially output on the analog signal line. The switch can subsequently be operated such that a different selection of the data signals is output on the analog signal line. As a result, the switch 158 can be operated such that data signals associated with different channel indices are serially output on the analog signal line. The electronics can include a switch controller 162 configured to operate the switch 158 so as to select the selection of the data signals that are output from the switch 158. Suitable switches include, but are not limited to, an N×1 switch, an N to 1 switch, a data selector, an electrical multiplexer.

The data processor 155 includes a beat frequency identifier 164 that receives the data signals from the switch 158. In particular, the beat frequency identifier 164 can be configured to serially receive from the analog signal line 160 data signals associated with different channel indices. The beat frequency identifier 164 is configured to identify the beat frequency of the data signal. The beat frequency identifier 164 includes an Analog-to-Digital Converter (ADC) 168 that receives the data signals from the analog signal line 160. The Analog-to-Digital Converter (ADC) 168 converts the data signal from an analog form to a digital form and outputs a digital data signal. The digital data signal is a digital representation of the data signal. Accordingly, the digital data signals are each associated with one of the channel indices. Since the switch controller 162 can operate the switch 158 such that data signals associated with different channel indices are serially output on the analog signal line, the Analog-to-Digital Converter (ADC) 168 receives serially receives data signals that are associated with different channel indices and outputs digital data signals that are associated with different channel indices.

The beat frequency identifier 166 includes a mathematical transformer 170 configured to receive the digital data signal. The mathematical transformer 170 is configured to perform the mathematical operation on the received digital data signal. Examples of suitable mathematical operations include, but are not limited to, mathematical transforms such as Fourier transforms. In one example, the mathematical transformer 170 performs a Fourier transform on the digital signal so as to convert from the time domain to the frequency domain. The mathematical transform can be a real transform such as a real Fast Fourier Transform (FFT). A real Fast Fourier Transform (FFT) can provide an output that indicates magnitude as a function of frequency.

The mathematical transformer 170 can include a peak finder (not shown) configured to identify peaks in the output of the mathematical transformer 170. The peak finder can be configured to identify any frequency peaks associated with reflection of the system output signal by one or more objects located outside of the LIDAR system. For instance, frequency peaks associated with reflection of the system output signal by one or more objects located outside of the LIDAR system can fall within a frequency range. The peak finder can identify the frequency peak within the range of frequencies associated with the reflection of the system output signal by one or more objects located outside of the LIDAR system. The frequency of the identified frequency peak represents the beat frequency of the composite signal.

The electronics include a LIDAR data generator 172 that receives the output from the mathematical transformer 170. For instance, the LIDAR data generator 172 can receive beat frequency from the LIDAR data generator 172. The LIDAR data generator 172 treats the frequency at the identified peak as the beat frequency of the comparative signal beating against all or a portion of a reference signal. The LIDAR data generator 172 can use the received beat frequencies in combination with the frequency pattern of the LIDAR output signals and/or the system output signals to generate LIDAR data results.

FIG. 5C illustrates an example of suitable frequency patterns for the outgoing LIDAR signals and the resulting system output signals and LIDAR output signals. The light source controller 62 can operate the light source 10 such that the outgoing LIDAR signals output from the light source 10 have a frequency versus time pattern according to FIG. 5C. There are three frequency versus time patterns shown in FIG. 5C. Each of the frequency versus time patterns is associated with one of the channel indices as shown by the labels m=1 through m=3. The frequency versus time pattern labeled m can represent the frequency versus time pattern for the outgoing LIDAR signal associated with the channel m.

The frequency versus time patterns can be periodic as shown in FIG. 5C. Each of the outgoing LIDAR signals has a frequency versus time pattern that periodically repeats in cycles. For instance, FIG. 5C labels different cycles for the outgoing LIDAR signal associated with channel index m=1 through m=3=M. The different cycles are labeled C_{m,k} where m represents the channel index and k is a cycle index. As a result, C_{3,10} can represent the tenth cycle of the system output signal associated with the channel index m=3. The periods of the cycles associated with different cycle indices can be the same as shown in FIG. 5C. As a result, the periods of the cycles can be represented by P. The cycles are phase shifted relative to one another. For instance, each of the frequency versus time patterns has a cycle that is shifted by +/−(P/(2M)) relative to at least one of the other frequency versus time patterns. The cycle indices can be assigned to the cycles such that corresponding data periods from the cycles associated with different channel indices as assigned the same cycle index. For instance, the cycle indices can be assigned to the cycles such that each of the cycles has a frequency that corresponds to a frequency in each of the other cycles and is within (P(M−1)/(2M)) of the corresponding frequencies in each of the other cycles. As an example, in FIG. 5C, each of the cycles has a base frequency labeled f₀ and the base frequency of each cycle assigned cycle index k is within P/3 of base frequencies of the other cycles assigned cycle index k.

Each cycle includes multiple chirp periods labeled CP_{m,j} where m represents the channel index and j is a chirp period index with a value from 1 to J. Accordingly, CP_{1,2} represents the second chirp period for the outgoing LIDAR signal associated with channel index m=1. Each of the cycles shown in FIG. 5C includes two chirp periods (J=2). The duration of different chirp periods in the same cycle can optionally be the same or can be different. In FIG. 5C, the chirp periods have the same duration. The chip rate can be constant, or substantially constant during each of the chirp periods in a cycle. As a result, the chirp can be a linear chirp. The chirp rates for the chirp periods in the same cycle can be the same or different and can be in the same or different directions. For instance, the chirp rates in each chirp period of FIG. 5C are the same but the chirp direction in different chirp periods within the same cycle are in opposite directions. The start time of each cycle coincides with the start of one of the chirp periods in the cycle.

The chirp period indices can be assigned such that corresponding chirp periods in the outgoing LIDAR signals associated with different channel indices are assigned the same chirp period index. For instance, FIG. 5C shows each of the chirp periods with an increasing frequency are assigned a chirp period index with a value of 1 while each of the chirp periods with a decreasing frequency are assigned a chirp period index with a value of 2.

The total change in the frequency that occurs during a chirp period can be considered a magnitude of the frequency change during the chirp period (chirp bandwidth). The chirp bandwidth during the chirp periods in the same cycle can be the same or different. In FIG. 5C, the chirp bandwidth during each of the chirp periods is constant or substantially constant; however, a portion of the chirp periods have different directions for the total change in the frequency that occurs during a chirp period.

As noted above, the switch controller 162 can operate the switch 158 so as to control which one of the data signals is received at the Analog-to-Digital Converter (ADC) 168. FIG. 5C illustrates the relationship between the frequency versus time patterns and the receipt of different data signals at the Analog-to-Digital Converter (ADC) 168. For instance, FIG. 5C includes multiple different switch windows labeled W_{m,j} where m represents the channel index and j represents the chirp period index. A switch window represents the time period during which the switch controller 162 directs the data signal associated with a particular one of the channel indices to the Analog-to-Digital Converter (ADC) 168. For instance, the switch windows labeled W_{2,2} represents a time period where the data signal associated with channel index m=2 is directed to the Analog-to-Digital Converter (ADC) 168 during a second chirp period (j=2).

The beat frequency identifier 164 can identify the beat frequency of the data signal received by the Analog-to-Digital Converter (ADC) 168 during a switch window (W_{m,j}) in a cycle associated with the same channel index as the switch window (W_{m,j}). The cycles C_{m,k} is associated with the same channel index as the switch window W_{m,j}. For instance, FIG. 5C has two switch windows (W_{2,j}) associated with the cycle labeled C_{2,k}. Using FIG. 5C as an example, the beat frequency identifier 164 can identify the beat frequency of the data signal received by the Analog-to-Digital Converter (ADC) 168 during the switch window W_{2,1} of the cycle labeled C_{2,k} and/or during the switch window W_{2,1} of the cycle labeled C_{2,k}. Accordingly, the beat frequencies identified by that beat frequency identifier 164 can be represented by bf_{m,j,k} where m represents the channel index, j represents the chirp period index, and k represents the cycle index. As an example, a beat represented by bf_{3,2,10} represents the beat frequency identified for the data signal directed to the Analog-to-Digital Converter (ADC) 168 during the switch window W_{3,2} of cycle C_{3,10}. The beat bf_{3,2,10} can also be considered to represent the beat frequency for the data signal that occurs during the second chirp period in the tenth cycle for the outgoing LIDAR signal, LIDAR output signal, and/or system output signal associated with the channel index m=3.

The beat frequencies are each associated with the switch window where the Analog-to-Digital Converter (ADC) 168 received the data signal from which the beat frequency was calculated. For instance, the beat frequency bf_{m,j,k} is associated with the switch window W_{m,j} of cycle C_{m,k}. As an example, the beat frequency bf_{3,1,2} represents the beat frequency calculated from the data signal received by the Analog-to-Digital Converter (ADC) 168 during switch window W_{3,1} of cycle C_{3,2}.

The beat frequencies are each associated with the cycle that includes the switch window associated with the beat frequency. For instance, the beat frequency bf_{m,j,k} is associated with the cycle C_{m,k}. As an example, each of the beat frequencies represented by bf_{3,j,2} are associated with the cycle C_{3,2}.

Each of the switch windows is associated with the chirp period that includes the switch window. For instance, the switch window W_{m,j} associated with cycle C_{m,k} is associated with the chirp period CP_{m,j} from the same cycle (C_{m,k}). As an example, in FIG. 5C, the switch window labeled W_{2,2} associated with the cycle labeled C_{2,k} is associated with the chirp period CP_{2,2} within the cycle labeled C_{2,k}.

Each of the switch windows can be positioned at the end of the associated chirp period. FIG. 5C illustrates each switch window extending to, or including, the end of the associated chirp period. For instance, each switch window W_{m,j} can open up at, or after, a lower time limit and close at, or before, an upper time limit. The lower time limit for switch window W_{m,j} can be at, or after: ((the start of chirp period CP_{m,j})+(M−1)CP_{m,j}/M)) and/or the upper time limit can be at or before the end of chirp period CP_{m,j} where CP_{m,j} represents the chirp period associated with switch window W_{m,j}. As a result, the switch window W_{m,j} can open up at, or after, the start of the chirp period CP_{m,j}+(M−1)CP_{m,j}/M and closes at, or before, the end of the chirp period CP_{m,j} where CP_{m,j} represents the chirp period associated with switch window W_{m,j}. Accordingly, the lower time limits are at ((the start of each one of the chirp periods)+((M−1)/M)*(the duration of the chirp period)). The upper time limits are at the end of the each one of the chirp periods. The data signal associated with channel index m is output from the switch during the switch windows that close at, or before, the end of the chirp periods associated with the channel index m. Each of the switch windows closes at, or before, the first one of the upper time limits that occurs after the switch window opens. This placement of the switch window at the end of the associated chirp period increases the amount of time available for a system return signal to return to the LIDAR system while still produce a data signal with a beat frequency that can be measured by the beat frequency identifier 164. As a result, the placement of the switch window at the end of the associated chirp period can increase the maximum operable distance of the LIDAR system.

FIG. 5C also illustrates multiple sample regions. The sample regions can be represented by SR_{m,i} where m represents the channel index and i represents a sample region index. The sample region SR_{m,i} represents the portion of the LIDAR system's field of view that is illuminated by one or more of the system output signal during the chirp periods that are used to generate LDAR data for that sample region. More particularly, the sample region SR_{m,i} represents the portion of the LIDAR system's field of view that is illuminated by one or more of the system output signals during the chirp periods that include switch windows that are the source of the beat frequencies that are used to calculate the LDAR data for the sample region SR_{m,i}. In FIG. 5C, the chirp periods and switch windows that are used to generate LDAR data for each sample region are from the same cycle and are accordingly associated with the same channel index. As a result, each sample region is associated with a single cycle. This result allows the value of i for each sample region to be the same as the value of the cycle index k associated with the sample region which can be expressed as: i=k. Accordingly, the sample regions that result from the frequency versus time pattern of 5C can be expressed as SR_{m,k} where m represents the channel index and k represents the cycle index. The time during which sample region SR_{m,k} is illuminated by the system output signal associated with channel index m is labeled SR_{m,k} in FIG. 5C. As a result, the label SR_{2,k+1}. In FIG. 5C identifies the time during which the (k+1)^{th} sample region is illuminated by the system output signal associated with the channel index m=2. As noted above, the sample regions can serve as three-dimensional pixels that can be stitched together to define the field of view for the LIDAR system. Each of the LIDAR data results generated by the LIDAR data generator 172 represents the LIDAR data for a sample region. The LIDAR data for a sample region can indicate the radial velocity and/or distance between the LIDAR system and an object in the sample region.

FIG. 5C illustrates each of the outgoing LIDAR signals at a different wavelength in order to simplify the illustration. Changing the wavelengths of the outgoing LIDAR signals shown in FIG. 5C can produce a shift upward or downward in the frequency versus time pattern for the outgoing LIDAR signal. As noted above, the outgoing LIDAR signals can have the same wavelengths.

Since the LIDAR output signals and the system output signals include or consist of light from the outgoing LIDAR signals, the frequency versus time pattern disclosed in the context of FIG. 5C can represent the frequency versus time pattern for the resulting LIDAR output signals, the resulting system output signals, and other signals that include or consist of light from the outgoing LIDAR signals.

The LIDAR data generator 172 can combine the beat frequencies from multiple different composite signal generators 32 to generate a LIDAR data result for each of the sample regions. For instance, the LIDAR data generator 172 can combine the beat frequencies calculated from multiple different switch windows that are each associated with the same cycle. As an example, a LIDAR data generator 172 can calculate the LIDAR data results for sample region SR_{2,k} from bf_{2,1,k} and bf_{2,2,k}. When this example is applied to FIG. 5C, the data generator 172 can calculate the LIDAR data results for sample region labeled SR_{2,k} from the beat frequencies calculated from the data signals received by the Analog-to-Digital Converter (ADC) 168 during switch windows W_{2,1} and W_{2,2} of the cycle labeled C_{2,k}.

The following equation applies to beat frequencies (bf_{m,j,k}) generated from switch windows where the frequency of the system output signal increases during the switch window such as occurs during the switch window W_{2,1} of the cycle labeled C_{2,k} in FIG. 5C: f_{ub}=−f_{d}+α_{uτ0} where f_{ub} is a beat frequency identified by the beat frequency identifier 164 and is associated with the switch window, f_{d} represents the Doppler shift (f_{d}=2νfₒ/c) where f₀ is the frequency of the system output signal at the start of the data period that includes the switch window, ν is the radial velocity between the reflecting object and the LIDAR chip where the direction from the reflecting object toward the chip is assumed to be the positive direction, and c is the speed of light, αᵤ represents the chirp rate during the sample period, and τ₀ is the roundtrip delay (time between the system output signal exiting from the LIDAR system and the system return signal returning to the LIDAR system) for a stationary reflecting object. The following equation applies to beat frequencies (bf_{m,j,k}) generated from switch windows where the frequency of the system output signal increases during the switch window such as occurs during the switch window W_{2,2} of the cycle labeled C_{2,k} in FIG. 5C: −f_{d}−α_{dτ0} where f_{db} is a beat frequency identified by the beat frequency identifier 164 and is associated with the switch window and α_{d} represents the chirp rate during the sample period. In these two equations, f_{d} and τ₀ are unknowns. These two equations are solved for the two unknowns f_{d} and τ₀. The LIDAR DATA generator can substitute the beat frequencies associated with the same cycle into the solution to generate the LIDAR data for the sample region associated with the cycle. For instance, the LIDAR DATA generator can calculate the radial velocity for an object in a sample region from the Doppler shift (ν=c*f_{d}/(2f_{c})) and/or the separation distance for the object in the sample region from c*τ₀/2. As an example, to generate the LIDAR data for the sample region labeled SR_{2,k} in FIG. 5C, the LIDAR DATA generator can substitute the values of bf_{2,1,k} and bf_{2,2,k} into the solution to calculate the radial velocity for an object in the sample region labeled SR_{2,k} in FIG. 5C from the Doppler shift (ν=c*f_{d}/(2f_{c})) and/or the separation distance for the object in the sample region from c*τ₀/2. As a result, the LIDAR data result for a region is calculated from beat frequencies that are calculated from multiple different switch windows from the same cycle. As a result, the LIDAR data result for a sample region is calculated from multiple beat frequencies that are each associated with the same cycle and the same channel index. Accordingly, each of the LIDAR data results can be associated with one of the channel indices.

In FIG. 5C, the cycles periods are defined starting from the lowest frequency of each outgoing LIDAR signal (the base frequency labeled f₀); however, an alternate set of cycles can be defined starting from the highest frequency of each outgoing LIDAR signal. To illustrate this result in FIG. 5C, multiple cycles are labeled C′_{m,k} and the associated sample region are labeled SR′_{m,k} The LIDAR data generator 172 can generate LIDAR data results for these sample regions as described above. The LIDAR data results for these sample regions can be generated in addition to the LIDAR data results for the sample regions represented by the SR_{m,k} labels or as an alternative to the sample regions represented by the SR_{m,k} labels. When LIDAR data results are generated for the sample regions represented by the SR′_{m,k} and the sample regions represented by the SR′_{m,k}, the illumination of adjacent sample regions by the same system output signal overlap in time and accordingly in space. Further, as shown in FIG. 5C, each one of all or a portion of beat frequencies (bf_{m,j,k}) can be used in the calculation of LIDAR data results for more than one sample region. As an example, the beat frequency calculated from the switch window w_{2,2} in the cycle labeled C_{2,k} can be used to calculate LIDAR data for the sample region labeled SR_{2,k} and can also be used to calculate LIDAR data for the sample region labeled SR′_{2,k}.

Each of the cycles shown in FIG. 5C includes two chirp periods, however, the cycles can include more than two chirp periods. As an example, FIG. 5D shows the frequency versus time patterns of FIG. 5C modified such that each cycle includes three chirp periods. Two of the chirp periods in each cycle can be used to calculate LIDAR data results for a sample region as described above. However, in some instances, the beat frequency identifier 164 can provide more than one solution for a beat frequency and accordingly more than one LIDAR data result. The multiple beat frequencies and/or multiple LIDAR data results can be caused by multiple objects being present in a sample region or can result from an ambiguous solution for the beat frequency as can occur from the use of a real FFT. The third beat frequency in each cycle provides an additional relationship between a beat frequency from the cycle, f_{d} and τ₀. The additional relationship for a beat frequency in a cycle can be used to identify which of the other beat frequencies associated with the same cycle are correct and/or to identify the correct LIDAR data solutions for the sample region associated with the cycle.

The frequency versus time pattern disclosed in the context of FIG. 5C and FIG. 5D is suitable for use with a LIDAR system where the system output signals associated with different channel indices are concurrently directed to different sample regions. FIG. 5E illustrates a frequency versus time pattern suitable for use with a LIDAR system where the system output signals associated with different channel indices are concurrently directed to the same sample region. For instance, FIG. 5E illustrates frequency versus time patterns for two outgoing LIDAR signals at different wavelengths that can each be concurrently directed to the same sample region. The cycles, chirp periods, and switch windows are configured as disclosed in the context of FIG. 5C and FIG. 5D. As noted above, the sample regions can be represented by SR_{m,i} where m represents the channel index and i represents a sample region index. In FIG. 5E, the time during which the sample regions are illuminated are labeled SR_{M,i}. The M in the expression SR_{M,i} indicates that each of the system output signals associated with channel indices 1 through M illuminates the i^{th} sample region. As a result, the label SR_{M,i+1} in FIG. 5E identifies the time during which the (i+1)^{th} sample region is illuminated by each of the system output signals associated with the channel indices 1 through M.

As with the frequency versus time patterns of FIG. 5C and FIG. 5D, the LIDAR data generator 172 can combine the beat frequencies from multiple different composite signal generators 32 to generate a LIDAR data result for each of the sample regions illustrated in FIG. 5E. For instance, the LIDAR data generator 172 calculates LIDAR data for a sample region from multiple beat frequencies that are from switch windows that are each associated with a different channel index and different chirp period index. Accordingly, the LIDAR data generator 172 can calculate LIDAR data for a sample region from beat frequencies that are associated with different channel index and different chirp period index. In some instances, the LIDAR data generator 172 calculates LIDAR data for a sample region from beat frequencies that are each associated with a different channel index, a different chirp period index, and the same cycle index. As an example, a LIDAR data generator 172 can calculate the LIDAR data results for sample region SR_{M,i} from bf_{1,2,k} and bf_{2,1,k} where the value of k is the same for both beat frequencies. Using FIG. 5E to illustrate this example, the data generator 172 can calculate the LIDAR data results for sample region labeled SR_{M,i+1} from the beat frequencies calculated from the data signals received by the Analog-to-Digital Converter (ADC) 168 during switch windows W_{2,1} of the cycle labeled C_{2,k} (bf_{2,1,k}) and W_{1,2} of the cycle labeled C_{1,k} (bf_{1,2,k}).

As with the frequency versus time patterns of FIG. 5C and FIG. 5D, the following equation applies to beat frequencies (bf_{m,j,k}) generated from switch windows where the frequency of the system output signal increases during the switch window such as occurs during the switch window W_{2,1} of the cycle labeled C_{2,k} in FIG. 5E: +f_{ub}=f_{d}+ατ₀ where f_{ub} is a beat frequency identified by the beat frequency identifier 164 and is associated with the switch window, f_{d} represents the Doppler shift (f_{d}=2νfₒ/c) where f₀ is the frequency of the system output signal at the start of the data period that includes the switch window, ν is the radial velocity between the reflecting object and the LIDAR chip where the direction from the reflecting object toward the chip is assumed to be the positive direction, and c is the speed of light, a represents the rate at which the frequency of the outgoing LIDAR signal is increased or decreased during the sample period, and τ₀ is the roundtrip delay (time between the system output signal exiting from the LIDAR system and the system return signal returning to the LIDAR system) for a stationary reflecting object. The following equation applies to beat frequencies (bf_{m,j,k}) generated from switch windows where the frequency of the system output signal increases during the switch window such as occurs during the switch window W_{1,2} of the cycle labeled C_{1,k} in FIG. 5C: −f_{db}=−f_{d}−ατ₀ where f_{db} is a beat frequency identified by the beat frequency identifier 164 and is associated with the switch window. In these two equations, f_{d} and τ₀ are unknowns. These two equations are solved for the two unknowns f_{d} and τ₀. The LIDAR DATA generator can substitute the beat frequencies associated with the same cycle into the solution to generate the LIDAR data for the sample region associated with the cycle. For instance, the LIDAR DATA generator can calculate the radial velocity for an object in a sample region from the Doppler shift (ν=c*f_{d}/(2f_{c})) and/or the separation distance for the object in the sample region from c*τ₀/2. As an example, to generate the LIDAR data for the sample region labeled SR_{M,i+1} in FIG. 5E, the LIDAR DATA generator can substitute the value of bf_{2,1,k} for f_{ub} and the value of bf_{1,2,k} f_{db} in the solution to calculate the radial velocity for an object in the sample region labeled SR_{M,i+1} in FIG. 5E from the Doppler shift (ν=c*f_{d}/(2f_{c})) and/or the separation distance for the object in the sample region from c*τ₀/2.

FIG. 5E illustrates two system output signals that concurrently illuminate each of the sample regions, however, there can be more than two system output signals that concurrently illuminate each of the sample regions. As an example, FIG. 5F shows the frequency versus time patterns of FIG. 5C modified such that three system output signals concurrently illuminate each of the sample regions. Each of the three system output signals have a different combination of chirp rate and chirp direction. For instance, in FIG. 4F, the system output signals associated with channel indices m=1 and m=2 have corresponding chirp periods with the same chirp rate but opposite chirp directions. Further, the system output signals associated with channel indices m=1 and m=2 have corresponding chirp periods with the same chirp rate but opposite chirp directions. The above Equations for f_{ub} and f_{db} can be used to calculate LIDAR data for a sample region from beat frequencies that are each associated with a different channel index and a different chirp period index as described in the context of FIG. 5E. In some instances, each of the beat frequencies is calculated from switch windows that are adjacent to one another in time. Because this approach permits a beat frequency to be used in the calculation of LIDAR data for multiple different sample regions, this approach can provide overlapping sample regions and can increase the resolution of the sample regions in the field of view.

In some instance, a first beat frequency and a second beat frequency can be used with the Equations for f_{ub} and f_{db} to calculate LIDAR data for each of the sample regions as described in the context of FIG. 5E; where the first beat frequency is associated with a first one of the channel indices and first one of the chirp period indices; the second beat frequency is associated with a second one of the channel indices and a second one of the chirp period indices; the first chirp period index is different from the second chirp period index; and the first channel index is different from the second channel index. However, as noted above, in some instances, the beat frequency identifier 164 provides more than one solution for a beat frequency and accordingly more than one LIDAR data result can be calculated for a sample region. The multiple beat frequencies and/or multiple LIDAR data results can be caused by multiple objects being present in a sample region or can result from an ambiguous solution for the beat frequency as can occur from the use of a real FFT. The presence of the additional system output signals provides an additional relationship between a beat frequency, f_{d} and τ₀. As a result, additional beat frequencies can be used to identify which of the other beat frequencies is correct and/or to identify the correct LIDAR data solutions for the sample region.

The sample regions shown in FIG. 5F are suitable for use of three system output signals to verify which of multiple LIDAR data results calculated for a sample region is/are the correct LIDAR data result. For instance, the beat frequency calculated from switch window labeled W_{3,1} of the cycle labeled C_{3,k} (bf_{3,1,k}), the beat frequency calculated from switch window labeled W_{1,2} of the cycle labeled C_{1,k}, (bf_{1,2,k}), and the beat frequency calculated from switch window labeled W_{2,2} of the cycle labeled C_{2,k} (bf_{2,2,k}) can be combined to calculate the LIDAR data for the sample region labeled SR_{M,i+3}. For instance, the beat frequencies bf_{3,1,k} and bf_{2,2,k} can be used in combination with the above equations for f_{ub} and f_{db} to calculate one or more first possible LIDAR data results for the sample region labeled SR_{M,i+3}. The beat frequencies bf_{3,1,k} and bf_{1,2,k} can be used in combination with the above equations for f_{ub} and f_{db} to calculate one or more second possible LIDAR data results for the sample region labeled SR_{M,i+3}. LIDAR data results that are common to the first possible LIDAR data results and the second possible LIDAR data results can be identified as the LIDAR data results for the sample region labeled SR_{M,i+3}. For instance, any first possible LIDAR data results that are equal to, or substantially equal to, a second possible LIDAR data result can be identified as an accurate LIDAR data results for the sample region labeled SR_{M,i+3} and any first possible LIDAR data results and/or any second possible LIDAR data results that are not identified as an accurate LIDAR data result for the sample region can be discarded. In this example, each set of possible LIDAR data results is calculated from beat frequencies associated with different chirp periods and/or chirp periods where the system output signals are chirped in opposite directions. Further, in this example, each of the beat frequencies (bf_{3,1,k}, bf_{1,2,k}, and bf_{2,2,k}) is associated with the same cycle index, however, the beat frequencies (bf_{3,1,k}, bf_{1,2,k}, and bf_{2,2,k}) can be associated with different cycle indices. For instance, the LIDAR data for the sample region labeled SR_{M,i+3} can be calculated from the beat frequencies (bf_{3,2,k}, bf_{1,1,k+1}, and bf_{2,1,k+1}). In each of the examples, the LIDAR data for a sample region is calculated from beat frequencies identified from test windows that are adjacent in time; however, the LIDAR data can be calculated from beat frequencies identified from test windows that are not adjacent in time. As an example, the LIDAR data for a sample region can be calculated from beat frequencies identified from M out of M, M+1, M+2, or M+3 test windows that are adjacent in time.

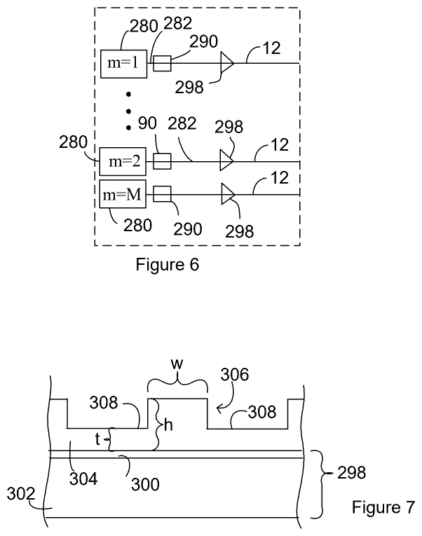

FIG. 6 illustrates an example of a light source 10 suitable for use in conjunction with the LIDAR system. The light source 10 includes multiple laser sources 280. Each of the laser sources 280 is configured to output a channel signal on a source waveguide 282. As noted above, the outgoing LIDAR signals can have different wavelengths or the same wavelengths. As a result, the different channel signals can have different wavelengths or the same wavelength.

Each laser source 280 can be associated with a different one of the channel indices. For instance, the laser source 280 associated with channel index m=1 is labeled m=1 and the laser source 280 associated with channel index m=2 is labeled m=2. The laser source 280 associated with channel index m outputs a channel signal associated with channel index m. A suitable laser source 280 includes, but is not limited to, semiconductor lasers such as External Cavity Lasers (ECLs), Distributed Feedback lasers (DFBs), Discrete Mode (DM) lasers and Distributed Bragg Reflector lasers (DBRs).

In some instances, each of the channel signals output from a laser source 280 serves as one of the outgoing LIDAR signals. The light source controller 62 can tune the frequency of the channel signal output from a laser source 280, and accordingly, the frequency of the resulting outgoing LIDAR signal, by tuning the electrical current through the laser source 280 and/or the bias level applied to the laser source 280. Since a different laser source 280 is the source of each outgoing LIDAR signal, the light source controller 62 can independently tune the frequency patterns of the outgoing LIDAR signals.

The light source 10 can optionally include one or more modulators 290 that are each positioned so as to modulate one of the channel signals. For instance, the light source 10 can optionally include one or more modulators 290 positioned along each of the source waveguides 282. When the light source 10 includes one or more modulators 290, the light source controller 62 can tune the frequency of the channel signal output from a laser source 280, and accordingly, the frequency of the resulting outgoing LIDAR signal, by tuning the electrical current through the modulator 290 and/or the bias level applied to the modulator 290. Since different modulators 290 can be operated to modulate the frequency patterns of different channel signals and the resulting outgoing LIDAR signals, the frequency patterns of the outgoing LIDAR signals and the resulting system output signals can be independently tuned. Suitable modulators 290 include, but are not limited to, thermal heaters, PIN carrier injection phase shifters, PN depletion-based phase shifters, and Mach-Zehnder modulators. An example of a suitable optical attenuator can be found in U.S. patent application Ser. No. 17/396,616, filed on Aug. 6, 2021, entitled “Carrier Injector Having Increased Compatibility,” and incorporated herein in its entirety.

The light source 10 can have a construction other than the construction illustrated in FIG. 6. For instance, the channel signals can be multiplexed onto an optical pathway such as an optical fiber or waveguide. The channel signals on the optical pathway can subsequently be demultiplexed into the outgoing LIDAR signals on the utility waveguides. The use of an optical fiber as the optical pathway allows the laser sources to be positioned off the LIDAR chip. The control branch 64 can have a construction other than the construction illustrated in FIG. 1. For instance, each of the control waveguides 68 can carry the control signal to a different feedback system 74 without carrying the control signal to an optical attenuator 70. Each of the feedback system 74 can be associated with a different one of the laser sources. During operation, the light source controller 62 can adjust the frequency of channel signals in response to output from the associated feedback system.

The LIDAR system can optionally include one or more light signal amplifiers in addition, or as an alternative, to any amplifiers 110. For instance, an amplifier 298 can optionally be positioned along all, or a portion, of the detector output line 154 as illustrated in FIG. 5B. As another example, an amplifier 298 can optionally be positioned along a utility waveguide 12 as illustrated in the light source 10 of FIG. 6. The electronics can operate the amplifier 298 so as to amplify the power of the outgoing LIDAR signal and accordingly of the resulting system output signal. Suitable amplifiers 298 for use on the LIDAR chip, include, but are not limited to, Semiconductor Optical Amplifiers (SOAs), transimpedance amplifiers, and SOA arrays.

Suitable platforms for construction for a LIDAR chip include, but are not limited to, silicon-on-insulator wafers, silica wafers, and silicon nitride on silicon wafers. FIG. 7 illustrates a portion of a LIDAR chip that includes a waveguide with a construction that is suitable for use with chips constructed from silicon-on-insulator wafers. A ridge 306 of the light-transmitting medium 304 extends away from slab regions 308 of the light-transmitting medium 304. The light signals are constrained between the top of the ridge and the buried layer 300. As a result, the ridge 306 at least partially defines the waveguide.

The dimensions of the ridge waveguide are labeled in FIG. 7. For instance, the ridge has a width labeled w and a height labeled h. The thickness of the slab regions is labeled t. For LIDAR applications, these dimensions can be more important than other applications because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally, or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. The waveguide construction of FIG. 7 is suitable for all or a portion of the waveguides on the LIDAR chip.

Light sensors that are interfaced with waveguides on a LIDAR chip can be a component that is separate from the chip and then attached to the chip. For instance, the light sensor can be a photodiode, or an avalanche photodiode. Examples of suitable light sensors include, but are not limited to, InGaAs PIN photodiodes manufactured by Hamamatsu located in Hamamatsu City, Japan, or an InGaAs APD (Avalanche Photo Diode) manufactured by Hamamatsu located in Hamamatsu City, Japan. These light sensors can be centrally located on the LIDAR chip. Alternately, all or a portion the waveguides that terminate at a light sensor can terminate at a facet located at an edge of the chip and the light sensor can be attached to the edge of the chip over the facet such that the light sensor receives light that passes through the facet. The use of light sensors that are a separate component from the chip is suitable for all or a portion of the light sensors selected from the group consisting of the first light sensor and the second light sensor.

As an alternative to a light sensor that is a separate component, all or a portion of the light sensors can be integrated with the chip. For instance, examples of light sensors that are interfaced with ridge waveguides on a chip constructed from a silicon-on-insulator wafer can be found in Optics Express Vol. 15, No. 21, 13965-13971 (2007); U.S. Pat. No. 8,093,080, issued on Jan. 10, 2012; U.S. Pat. No. 8,242,432, issued Aug. 14, 2012; and U.S. Pat. No. 6,108,8472, issued on Aug. 22, 2000 each of which is incorporated herein in its entirety. The use of light sensors that are integrated with the chip are suitable for all or a portion of the light sensors selected from the group consisting of the first light sensor and the second light sensor.

Suitable electronics 56 can include, but are not limited to, a controller that includes or consists of analog electrical circuits, digital electrical circuits, processors, microprocessors, digital signal processors (DSPs), Field Programmable Gate Arrays (FPGAs), computers, microcomputers, or combinations suitable for performing the operation, monitoring and control functions described above. In some instances, the controller has access to a memory that includes instructions to be executed by the controller during performance of the operation, control and monitoring functions. In some instances, the functions of a LIDAR data generator and the peak finder can be executed by Field Programmable Gate Arrays (FPGAs), digital signal processors (DSPs), Application Specific Integrated Circuits, firmware, software, hardware, and combinations thereof. Although the electronics are illustrated as a single component in a single location, the electronics can include multiple different components that are independent of one another and/or placed in different locations. Additionally, as noted above, all or a portion of the disclosed electronics can be included on the chip including electronics that are integrated with the chip.

An example of a suitable light source controller 62 executes the attributed functions using firmware, hardware, or software or a combination thereof. An example of a suitable data processor 155 executes the attributed functions using firmware, hardware, or software or a combination thereof. An example of a suitable steering controller 60 executes the attributed functions using firmware, hardware, or software or a combination thereof. An example of a suitable switch controller 162 executes the attributed functions using firmware, hardware, or software or a combination thereof.

Components on the LIDAR chip can be fully or partially integrated with the LIDAR chip. For instance, the integrated optical components can include or consist of a portion of the wafer from which the LIDAR chip is fabricated. A wafer that can serve as a platform for a LIDAR chip can include multiple layers of material. At least a portion of the different layers can be different materials. As an example, in a silicon-on-insulator wafer that includes the buried layer 300 between the substrate 302 and the light-transmitting medium 304 as shown in FIG. 6, the integrated on-chip components can be formed by using etching and masking techniques to define the features of the component in the light-transmitting medium 304. For instance, the slab regions 308 that define the waveguides and the stop recess can be formed in the desired regions of the wafer using different etches of the wafer. As a result, the LIDAR chip includes a portion of the wafer and the integrated on-chip components can each include or consist of a portion of the wafer. Further, the integrated on-chip components can be configured such that light signals traveling through the component travel through one or more of the layers that were originally included in the wafer. For instance, the waveguide of FIG. 7 guides light signal through the light-transmitting medium 304 from the wafer. The integrated components can optionally include materials in addition to the materials that were present on the wafer. For instance, the integrated components can include reflective materials and/or a cladding.

Numeric labels such as first, second, third, etc. are used to distinguish different features and components and do not indicate sequence or existence of lower numbered features. For instance, a second component can exist without the presence of a first component and/or a third step can be performed before a first step. The light signals disclosed above each include, consist of, or consist essentially of light from the prior light signal(s) from which the light signal is derived. For instance, an incoming LIDAR signal includes, consists of, or consists essentially of light from the LIDAR input signal.

Although the LIDAR system is disclosed as real signals such as the data signal, the LIDAR system can also use complex signals. As a result, the mathematical transform can be a complex transform and the component associated with the generation and use of a complex data signal having an in-phase component and a quadrature component can be added to the LIDAR system. As a result, the LIDAR system can use a multiple signal combiners and multiple ADCs. Additionally, or alternately, a single light sensor can replace each of the balanced detectors.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A system, comprising:
a LIDAR system configured to concurrently receive multiple different system return signals that have each been reflect by an object located external to the LIDAR system;
the LIDAR system including a data signal generator having multiple light sensors that are each configured to receive light from a different one of the system return signals,
the data signal generator configured to generate data signals that are each an electrical signal beating at a beat frequency, each of the data signals being generated from the light from a different one of the system return signals; and
the LIDAR system including an analog-to-digital converter configured to receive the data signal in series.

2. The system of claim 1, wherein the LIDAR system includes a switch configured to receive each of the data signals after the data signal is output from the data signal generator and the switch being configured to output one of the data signals before the data signal is received by the analog-to-digital converter.

3. The system of claim 2, wherein the switch is operable so as to output each of the different data signals in series.

4. The system of claim 2, wherein the LIDAR system includes a switch controller configured to operate the switch such that the switch outputs the different data signals in series.

5. The system of claim 2, wherein the switch is an electrical multiplexer.

6. The system of claim 1, wherein the LIDAR system includes a LIDAR data generator configured to calculate LIDAR data results from the beat frequencies, each LIDAR data result indicating a radial velocity and/or distance between the LIDAR system and an object located external to the LIDAR system.

7. The system of claim 1, wherein the LIDAR system is configured to concurrently transmit multiple different system output signals, each of the system return signals including light from a different one of the system output signals.

8. The system of claim 7, wherein the LIDAR system is configured to concurrently transmit multiple different system output signals such that a spot size of the system output signals overlap at a maximum operational distance of the LIDAR system.

9. The system of claim 7, wherein the LIDAR system is configured to concurrently transmit multiple different system output signals such that a spot size of the system output signals do not overlap at a maximum operational distance of the LIDAR system.

10. The system of claim 7, wherein the LIDAR system includes multiple composite signal generators, each composite signal generator configured to combine light from a different one of the system return signals with a reference signal so as generate a composite signal.

11. The system of claim 10, wherein the LIDAR system is configured such that the system return signal and the reference signal combined by each composite signal generator include light from a common outgoing LIDAR signal.

12. The system of claim 7, wherein the LIDAR system is configured such that each of the system output signals has a different wavelength.

13. The system of claim 7, wherein the LIDAR system is configured such that each of the system output signals has the same wavelength.

14. The system of claim 7, wherein the LIDAR system is configured to concurrently transmit M of the system output signals that each has a frequency versus time pattern, each of the versus time pattern being phase shifted relative to the other frequency versus time patterns.

15. The system of claim 7, wherein each of the frequency versus time patterns has a frequency of one of the system output signals repeated in cycles and each of the frequency versus time patterns are phase shifted by +/−(P/(2M)) relative to at least one of the other frequency versus time patterns where P represents a period of each cycle,
the period of each cycle being the same for each of the system output signals.

16. The system of claim 15, wherein each of the cycles includes two chirp periods, the frequency of each system output signal being linearly chirped during the two chirp periods.

17. The system of claim 16, wherein the LIDAR system includes a switch configured to receive each of the data signals after the data signal is output from the data signal generator and the switch being configured to output one of the data signals before the data signal is received by the analog-to-digital converter;
each of the system output signals can be associated with a different channel index (m) and the data signal generated from the system output signal associated with channel index m also can also associated with channel index m;
the LIDAR system include a switch controller configured to operate the switch such that each of the different data signals is output from the switch during a different switch window; and
each of the switch windows opens up at, or after, a lower time limit and closes at, or before, an upper time limit,
the lower time limits being at ((the start of each one of the chirp periods)+((M−1)/M)*(the duration of the chirp period)),
the upper time limits occur at the end of the each one of the chirp periods,
the data signal associated with channel index m being output from the switch during the switch windows that each closes at, or before, the end of one of the chirp periods associated with the channel index m; and
each of the switch windows closes at, or before, the first one of the upper time limits that occurs after the switch window opens.

18. The system of claim 17, wherein there are M time windows associated with each of the chirp periods.
